(19) United States
(12) Patent Application Publication
(10) Pub. No.: US 2026/0014501 A1
(43) Pub. Date: Jan. 15, 2026

(54) FILTER ASSEMBLY FOR WATER DISPENSER

(71) Applicant: Sloan Valve Company, Franklin Park, IL (US)

(72) Inventor: Carren Min Hua Chang, Kaohsiung City (TW)

(21) Appl. No.: 19/264,387

(22) Filed: Jul. 9, 2025

Related U.S. Application Data
(60) Provisional application No. 63/669,582, filed on Jul. 10, 2024.

(51) Int. Cl. B01D 35/30; B01D 27/00

(52) U.S. Cl. CPC B01D 35/306; B01D 27/00; B01D 2201/4061; B01D 2201/4076

(57) ABSTRACT

A filter cartridge for a water dispenser includes a connection portion having a base connected to a filter portion for filtering water to be supplied to the water dispenser, a fluid connection extending upward from the base, and one or more locking wings connected to the base and extending outward on opposite sides of the base. The fluid connection is configured to be in fluid communication with the filter portion and configured to permit passage of the water into and/or out of the filter portion. Each locking wing has a lip extending outwardly such that a space is defined between an underside of the lip and an upper side of the base, and each locking wing is configured to engage a flange on a filter head and to receive the flange in the space to lock the filter cartridge in connection with the filter head.

### CROSS-REFERENCE TO RELATED APPLICATION

This application is a nonprovisional of, and claims priority to, U.S. Provisional Application No. 63/669,582, filed Jul. 10, 2024, which prior application is incorporated by reference herein in its entirety.

### TECHNICAL FIELD

This disclosure relates to filter assemblies for water dispensers, and more specifically to a filter assembly including a filter cartridge and a filter head with corresponding fittings.

### BACKGROUND

Many water dispensers, including water fountains, bottle fillers, sinks, refrigerator water dispensers, ice makers, etc., use filter assemblies that include a removable and replaceable filter cartridge to filter various substances from the water to be dispensed. Such filter assemblies may include various different types of releasable connections between the filter cartridge and the filter head to which the cartridge is connected. However, such releasable connection structures may not adequately and consistently achieve alignment and fitting of the components to ensure optimum performance.

The present disclosure is provided to address this need and other needs in existing filter assemblies. A full discussion of the features and advantages of the present invention is deferred to the following detailed description, which proceeds with reference to the accompanying drawings.

### BRIEF SUMMARY

General aspects of the present disclosure relate to a filter assembly for a water dispenser, such as a water fountain, a bottle fill station, a sink, etc., that includes components to easily, quickly, and securely lock a filter cartridge into a filter head in a manner that permits the filter cartridge to filter the water that is supplied to the water dispenser and also facilitates removal and replacement of the filter cartridge when necessary. The filter cartridge has a connection portion that releasably connects to the filter head, and these components include complementary engaging structures to permit this connection and disconnection of the filter cartridge.

Aspects of the disclosure relate to a connection portion for a filter cartridge for a water dispenser, including a base configured for connection to a top end of a filter portion configured for filtering water to be supplied to the water dispenser, a fluid connection extending upward from the base, and first and second locking wings connected to the base and extending outward on opposite first and second sides of the base. The fluid connection is configured to be in fluid communication with the filter portion and configured to permit passage of the water into and/or out of the filter portion. The first locking wing has a first lip extending outwardly such that a first space is defined between an underside of the first lip and an upper side of the base, and the first locking wing is configured to engage a first flange on a filter head and to receive the first flange in the first space to lock the filter cartridge in connection with the filter head. The second locking wing has a second lip extending outwardly such that a second space is defined between an underside of the second lip and the upper side of the base, and the second locking wing is configured to engage a second flange on the filter head and to receive the second flange in the second space to lock the filter cartridge in connection with the filter head.

According to one aspect, the first and second locking wings are arranged in a rotationally symmetrical manner to define two identical rotational positions of the connection portion.

According to another aspect, the first lip has a first terminal edge distal from the fluid connection and a first slot extending inward from the first terminal edge, and the second lip has a second terminal edge distal from the fluid connection and a second slot extending inward from the second terminal edge. In one aspect, the first slot and the second slot are offset from a lateral centerline of the filter cartridge that passes through lateral centers of both the first locking wing and the second locking wing and through a lateral center of the fluid connection, and the first slot and the second slot are positioned on opposite sides of the lateral centerline. In this configuration, the first slot and the second slot may be offset equal distances from the lateral centerline, and the first and second locking wings may be arranged in a rotationally symmetrical manner to define two identical rotational positions of the connection portion. In another aspect, the first terminal edge and the second terminal edge are convexly curved.

Additional aspects of the disclosure relate to a filter cartridge for a water dispenser, including a connection portion according to aspects disclosed herein, and a filter portion connected to the connection portion and configured for filtering water to be supplied to the water dispenser.

Further aspects of the disclosure relate to a filter cartridge for a water dispenser, including a filter portion having a casing containing filtering components configured for filtering water to be supplied to the water dispenser and a connection portion connected to a top end of the filter portion. The connection portion includes a base connected to the top end of the filter portion, a fluid connection extending upward from the base, wherein the fluid connection is in fluid communication with the filter portion and configured to permit passage of the water into and/or out of the filter portion, and a first locking wing connected to the base and extending outward on a first side of the base. The first locking wing has a first lip extending outwardly such that a first space is defined between an underside of the first lip and an upper side of the base, and the first locking wing is configured to engage a first flange on a filter head and to receive the first flange in the first space to lock the filter cartridge in connection with the filter head.

According to one aspect, the connection portion further includes a plurality of locking wings including the first locking wing, each connected to the base and extending outward, with each locking wing having a lip extending outwardly such that a space is defined between an underside of each lip and the upper side of the base. Each locking wing is configured to engage a corresponding flange on the filter head and to receive the corresponding flange in the space to lock the filter cartridge in connection with the filter head. In one aspect, the plurality of locking wings are arranged in a rotationally symmetrical manner to define a number of identical rotational positions equal to a number of the plurality of locking wings.

According to another aspect, the first lip has a first terminal edge distal from the fluid connection, and a slot extending inward from the first terminal edge. The slot may be configured to receive a projection and to permit the projection to pass by the first lip when the connection portion is connected to the filter head.

According to a further aspect, the connection portion further includes a second locking wing connected to the base and extending outward on a second side of the base opposite to the first side, such that the first and second locking wings are positioned on opposite sides of the fluid connection, with the second locking wing having a second lip extending outwardly such that a second space is defined between an underside of the second lip and the upper side of the base. The second locking wing is configured to engage a second flange on the filter head and to receive the second flange in the second space to lock the filter cartridge in connection with the filter head. In one aspect, the first and second locking wings are arranged in a rotationally symmetrical manner to define two identical rotational positions of the connection portion. In another aspect, the first lip has a first terminal edge distal from the fluid connection and a first slot extending inward from the first terminal edge, and the second lip has a second terminal edge distal from the fluid connection and a second slot extending inward from the second terminal edge. The first and second slots may be configured to receive projections and to permit the projections to pass by the first and second lips when the connection portion is connected to the filter head. In this configuration, the first slot and the second slot may be offset from a lateral centerline of the filter cartridge that passes through lateral centers of both the first locking wing and the second locking wing and through a lateral center of the fluid connection, and the first slot and the second slot may also be positioned on opposite sides of the lateral centerline.

Yet additional aspects of the disclosure relate to a filter assembly for a water dispenser, including a filter cartridge according to aspects disclosed herein, and a filter head connected to the filter cartridge and configured for providing flow of water into and out of the filter cartridge.

Still further aspects of the disclosure relate to a filter assembly for a water dispenser, including a filter head having a frame having an outer wall defining a cavity, the cavity including a fluid receptacle, and a connecting structure comprising a first flange extending inward from the outer wall, and a filter cartridge connected to the filter head. The filter cartridge includes a connection portion having a base, a fluid connection extending upward from the base and received within the fluid receptacle to place the fluid connection in fluid communication with the fluid receptacle, and a first locking wing connected to the base and extending outward on a first side of the base. The first locking wing has a first lip extending outwardly, and the connection portion is at least partially received in the cavity and is connected to the filter head, such that the first flange engages an underside of the first lip to lock the connection portion in connection with the filter head. The filter cartridge also includes a filter portion configured for filtering water to be delivered to the water dispenser and having a top end connected to the base of the connection portion. The fluid connection of the connection portion is in fluid communication with the filter portion and configured to permit passage of the water into and/or out of the filter portion through the fluid receptacle.

According to one aspect, the filter head further includes an inlet port in fluid communication with the fluid receptacle and configured for receiving the water from a water supply and an outlet port in fluid communication with the fluid receptacle and configured for delivering the water to an outlet of the water dispenser. The fluid connection is configured to permit passage of the water from the inlet port into the filter portion and to permit passage of water out of the filter portion and into the outlet port, via the fluid receptacle.

According to another aspect, the connecting structure of the filter head further includes a second flange extending inward from the outer wall, and the connection portion further includes a second locking wing connected to the base and extending outward on a second side of the base opposite the first side. The second locking wing has a second lip extending outwardly, and the connection portion is further connected to the filter head such that the second flange engages an underside of the second lip to lock the connection portion in connection with the filter head. In one aspect, the connecting structure of the filter head further includes passages between the first flange and the second flange. The filter cartridge is configured to be releasably connectable to the filter head by inserting the connection portion into the cavity, such that the fluid connection is received in the fluid receptacle and the first locking wing and the second locking wing pass upwardly through the passages, and subsequently rotating the filter cartridge to cause the first flange to engage the underside of the first lip of the first locking wing and to cause the second flange to engage the underside of the second lip of the second locking wing. In this configuration, the connecting structure of the filter head may also include protrusions extending inwardly from the outer wall within the passages. The first lip has a first terminal edge distal from the fluid connection and a first slot extending inward from the first terminal edge, and the second lip has a second terminal edge distal from the fluid connection and a second slot extending inward from the second terminal edge, and the protrusions are configured to pass through the first slot and the second slot when the first locking wing and the second locking wing are inserted upward through the passages. Further, in this configuration, each of the protrusions may have a ramped surface, and the ramped surfaces of the protrusions are configured to engage the first locking wing and the second locking wing when the filter cartridge is rotated, to assist in raising the first locking wing and the second locking wing above the protrusions.

Other aspects of the disclosure relate to a water dispenser that includes a filter assembly according to aspects disclosed herein, and an outlet configured to receive filtered water that passes through the filter assembly.

Other features and advantages of the disclosure will be apparent from the following description taken in conjunction with the attached drawings.

### BRIEF DESCRIPTION OF THE DRAWINGS

To allow for a more full understanding of the present disclosure, it will now be described by way of example, with reference to the accompanying drawings in which:

FIG. 1 is a perspective view of one embodiment of a filter cartridge according to aspects of the disclosure;

FIG. 2 is a magnified view of a portion of the filter cartridge of FIG. 1;

FIG. 3 is a top view of the filter cartridge of FIG. 1;

FIG. 4 is a perspective view of one embodiment of a filter head according to aspects of the disclosure, which is configured for use with the filter cartridge of FIG. 1;

FIG. 5 is a bottom perspective view of the filter head of FIG. 4;

FIG. 6 is a bottom view of the filter head of FIG. 4;

FIG. 7 is a side view of one embodiment of a filter assembly according to aspects of the disclosure, including the filter cartridge of FIG. 1 into the filter head of FIG. 4, showing partial insertion of the filter cartridge into the filter head;

FIG. 8 is a cross-section view taken along lines 8-8 of FIG. 7;

FIG. 9 is a perspective cross-section view taken along lines 8-8 of FIG. 7;

FIG. 10 is a side view of the filter assembly of FIG. 7, showing complete insertion of the filter cartridge into the filter head, before rotational locking;

FIG. 11 is a cross-section view taken along lines 11-11 of FIG. 10;

FIG. 12 is a cross-section view taken along lines 12-12 of FIG. 10;

FIG. 13 is a partially-schematic perspective view of one embodiment of a water dispenser assembly according to aspects of the disclosure, including the filter assembly of FIG. 7, showing the filter cartridge and the filter head after rotational locking;

FIG. 14 is a side view of the filter assembly of FIG. 13;

FIG. 15 is a magnified perspective view of a portion of the filter assembly of FIG. 13; and

FIG. 16 is a cross-section view taken along lines 16-16 of FIG. 14.

### DETAILED DESCRIPTION

While this invention is susceptible of embodiments in many different forms, there are shown in the drawings and will herein be described in detail example embodiments of the invention with the understanding that the present disclosure is to be considered as an exemplification of the principles of the invention and is not intended to limit the broad aspect of the invention to the embodiments illustrated. In the following description of various example structures according to the invention, reference is made to the accompanying drawings, which form a part hereof, and in which are shown by way of illustration various example devices, systems, and environments in which aspects of the invention may be practiced. It is to be understood that other specific arrangements of parts, example devices, systems, and environments may be utilized and structural and functional modifications may be made without departing from the scope of the present invention.

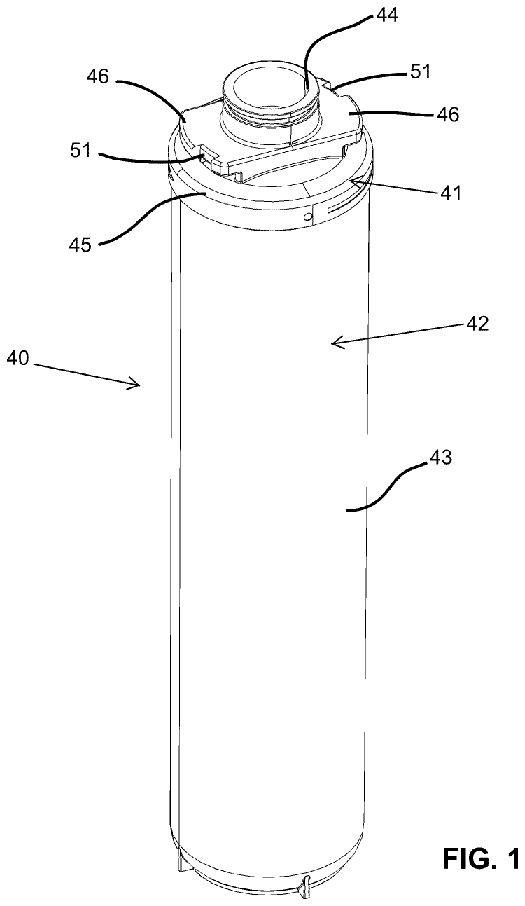

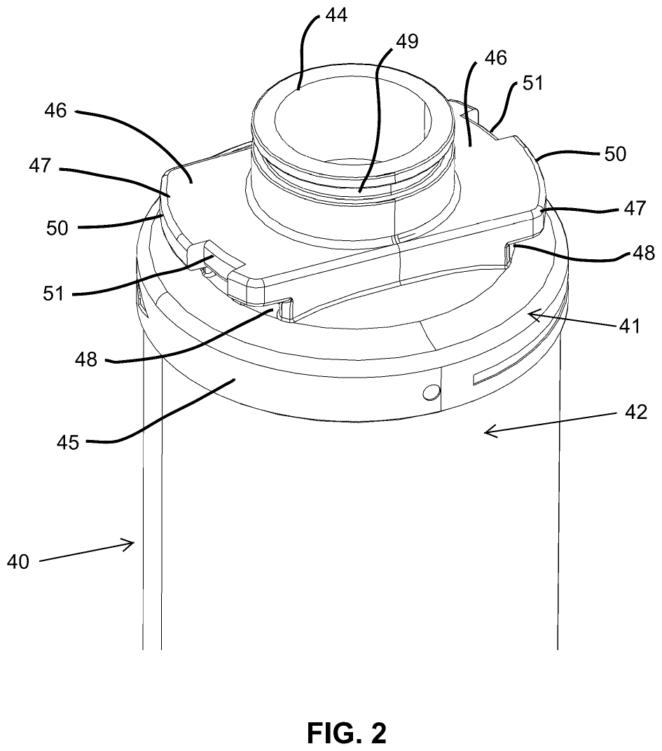

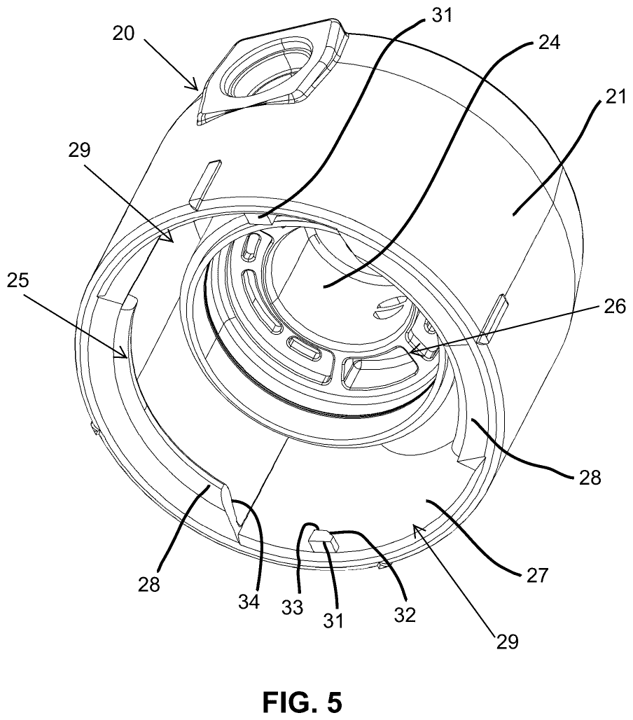

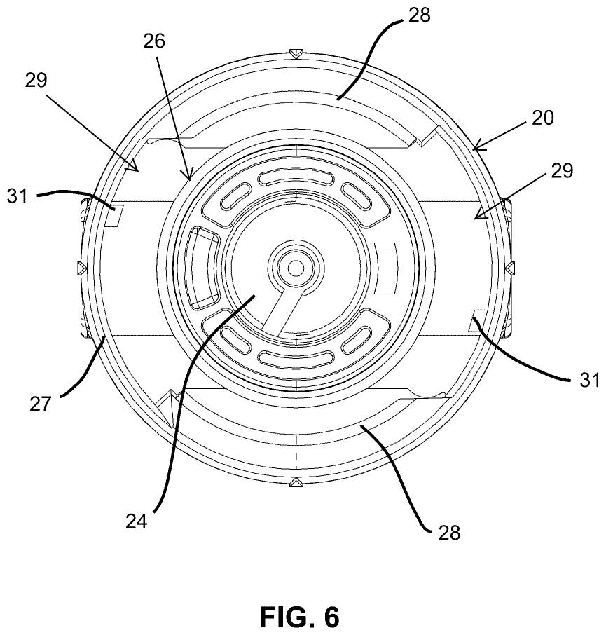

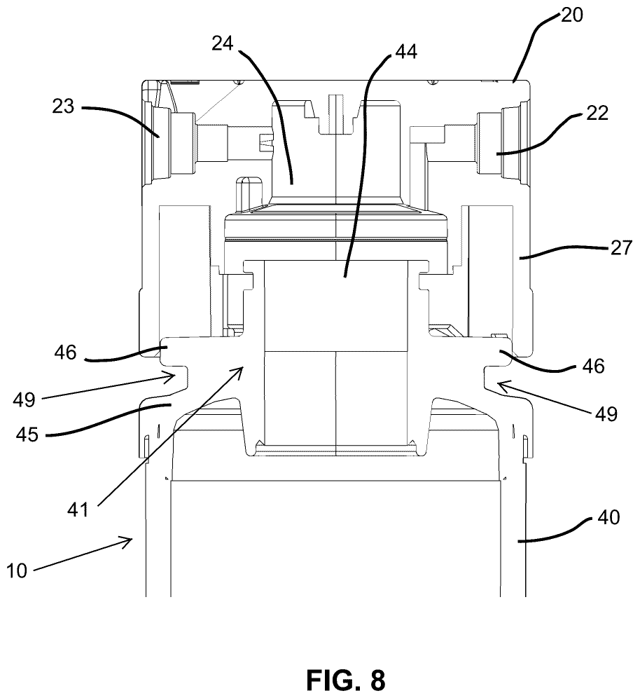

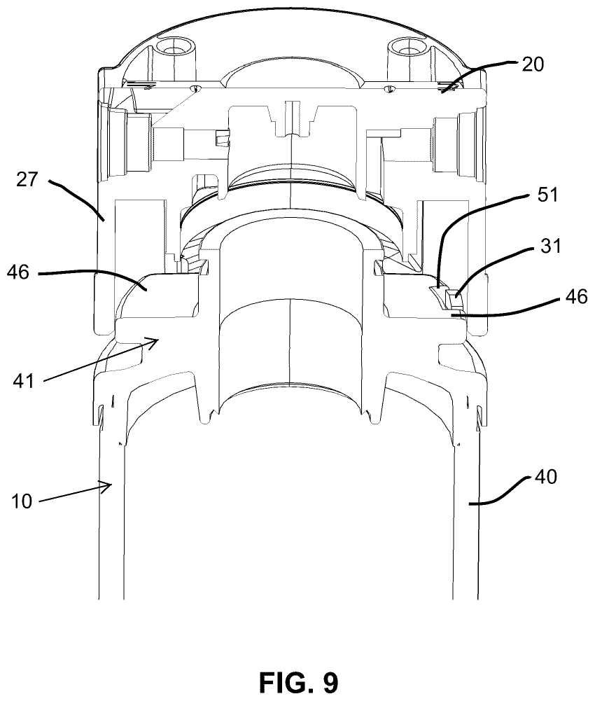

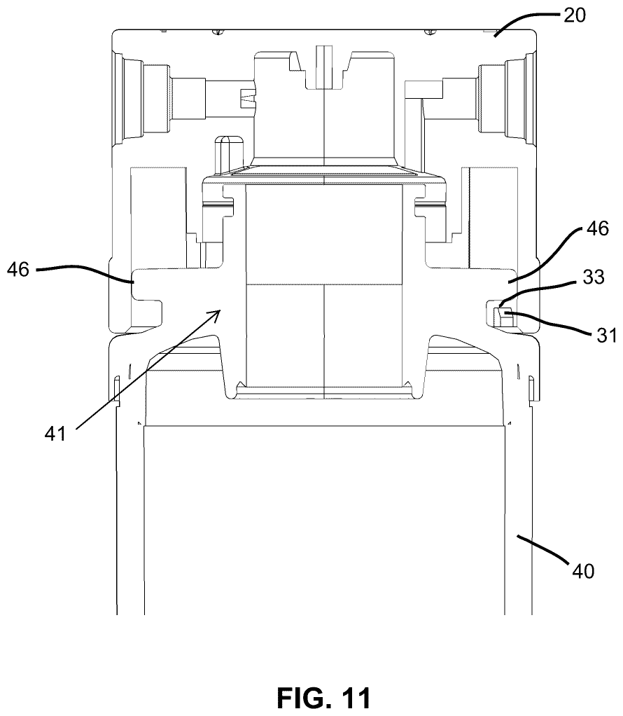

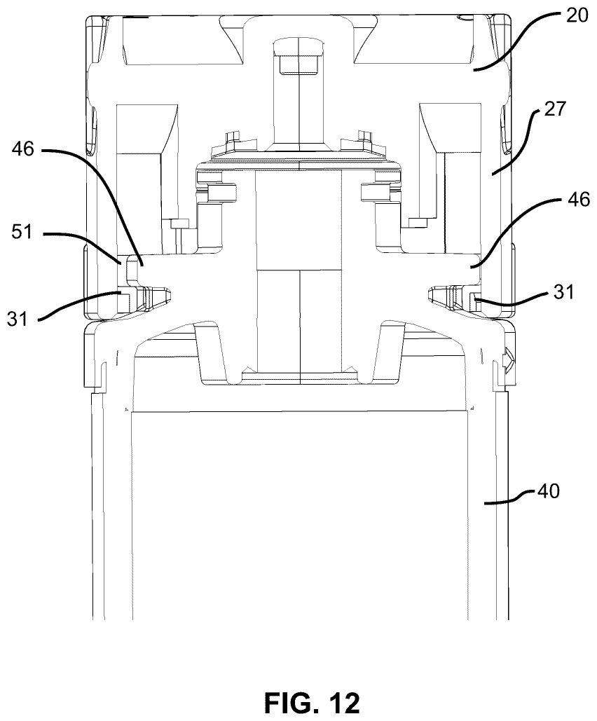

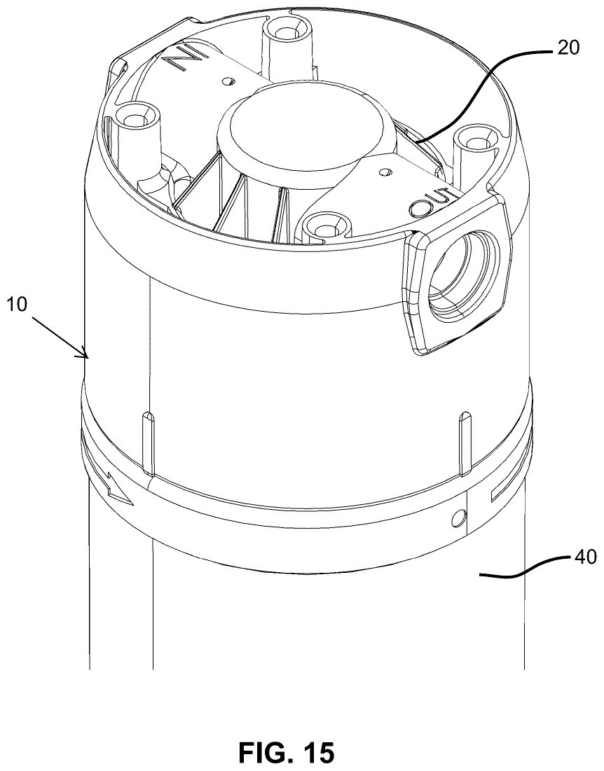

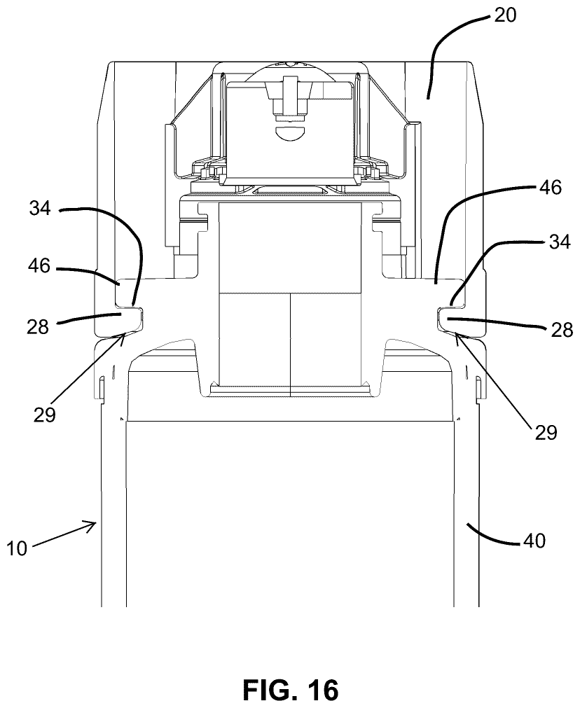

FIGS. 1-16 illustrate one embodiment of a filter assembly 10 for a water dispenser, which includes at least a filter head 20 and a filter cartridge 40. The filter head 20 is configured to be a permanent portion of the water dispenser assembly, although removal and replacement in the event of malfunction is contemplated. The filter cartridge 40 is configured to be removed and replaced periodically, and the filter head 20 and the filter cartridge 40 include complementary engaging structures to removably retain the filter cartridge 40 in connection with the filter head 20.

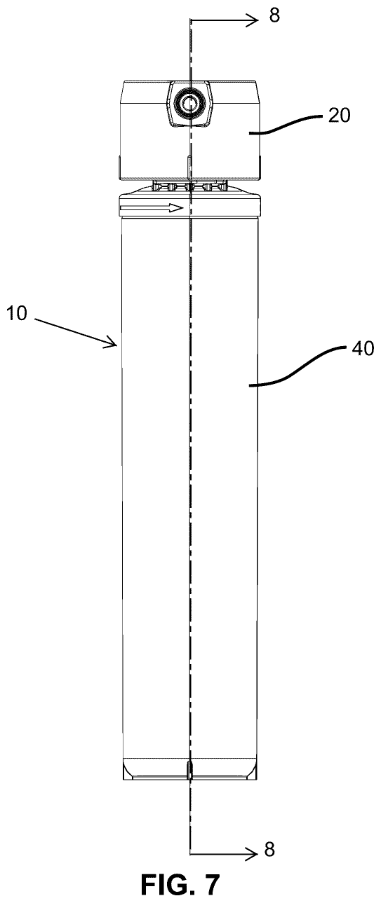

The filter cartridge 40 is illustrated alone in FIGS. 1-3 and along with the filter head 20 in FIGS. 7-16. The filter cartridge 40 includes a connection portion 41 configured for connection with the filter head 20 and a filter portion 42 that includes a casing 43 that contains filtering components. It is understood that the filter portion 42 may include various different structures and materials, depending on the type of filtering desired. The connection portion 41 includes a fluid connection 44 at the top, through which water can pass into and out of the filter cartridge 40. The fluid connection 44 may include a groove 49 to receive a grommet (not shown) or other seal. The internal components of the filter cartridge 40 and the structures to which the connection portion 41 connects will include appropriate components to separate water passing into and out of the filter cartridge 40, as known in the art.

The connection portion 41 includes a base 45, with the fluid connection 44 extending upward from the base 45, and two locking wings 46 positioned above the base 45 and extending outward from opposite sides of the base 45 and the fluid connection 44. In other embodiments, a different number of locking wings 46 is included, such as a single locking wing 46 or three or more locking wings 46, and in various embodiments, the connection portion 41 may include at least one, or a plurality of, locking wings 46. The locking wings 46 are configured to engage structures of the filter head 20, as described herein, to retain the filter cartridge 40 in connection with the filter head 20. Each locking wing 46 has a lip 47 that extends outwardly, with a space 48 defined between the underside of the lip 47 and the upper side of the base 45 of the connection portion 41. Each lip 47 in the embodiment of FIGS. 1-16 has a convexly curved terminal edge 50, i.e., the edge of the lip 47 that is furthest outward and/or distal from the fluid connection 44, but this configuration may be different in other embodiments. One or more of the locking wings 46 may include a slot 51 extending inward from the terminal edge 50 of the lip 47. The filter cartridge of FIGS. 1-16 has two locking wings 46, each including a slot 51, and the slots 51 in this embodiment are rectangular slots defined entirely within the lip 47. In another embodiment, a slot 51 may be located at an end of the terminal edge 50, and/or differently shaped slot(s) 51 may be used. In a further embodiment, each locking wing 46 may include multiple slots 51.

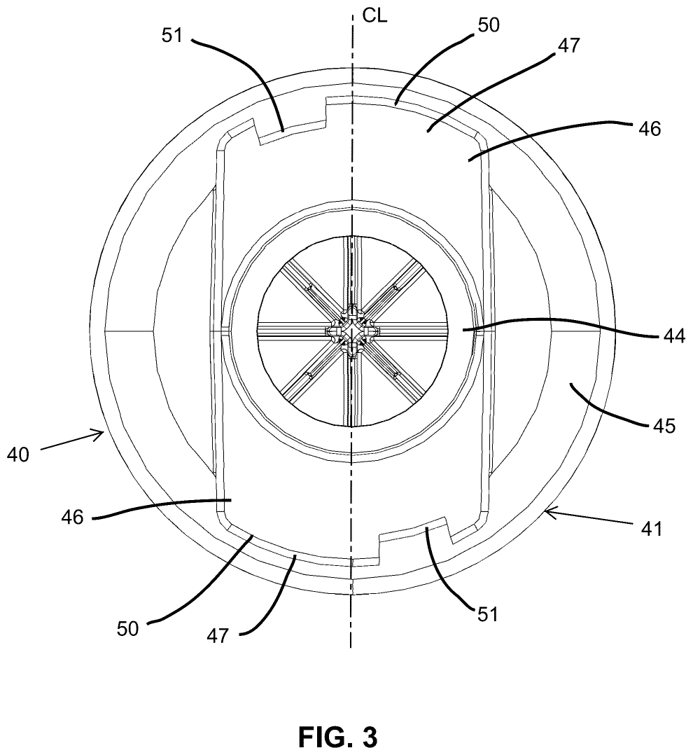

In one embodiment, the slots 51 may be positioned such that the locking wings 46 collectively are rotationally symmetrical, i.e., that the shape defined by all of the locking wings 46 collectively appears identical from the top view (FIG. 3) in a plurality of different rotational positions. The slots 51 in the locking wings 46 in FIGS. 1-16 are positioned on opposite but symmetrical sides of a lateral centerline CL of the filter cartridge 40, as shown in FIG. 3, and the slots 51 are offset equal distances of the lateral centerline CL. In this configuration, if the filter cartridge 40 is rotated 180° in either direction in FIG. 3, the shape defined by the locking wings 46 is the same. Thus, the locking wings 46 in FIGS. 1-16 define two different identical rotational positions. It is understood that the number of identical rotational positions defined may depend on the number and configuration of the locking wings 46, and the number of identical rotational positions may be equal to the number of locking wings 46. For example, a structure including three locking wings 46 may define three different identical rotation positions rotated 120° from each other. Further, while the slots 51 in this embodiment are offset from the lateral centerline CL of the filter cartridge 40, and thus do not confer planar symmetry, a symmetrical configuration may be used in another embodiment. For example, in other embodiments, the slots 51 may be located on the lateral centerline CL, or additional slots 51 may be positioned in a symmetrical manner about the lateral centerline CL. The lateral centerline CL in this configuration passes through the lateral centers of both of the locking wings 46 and through the lateral center of the fluid connection 44.

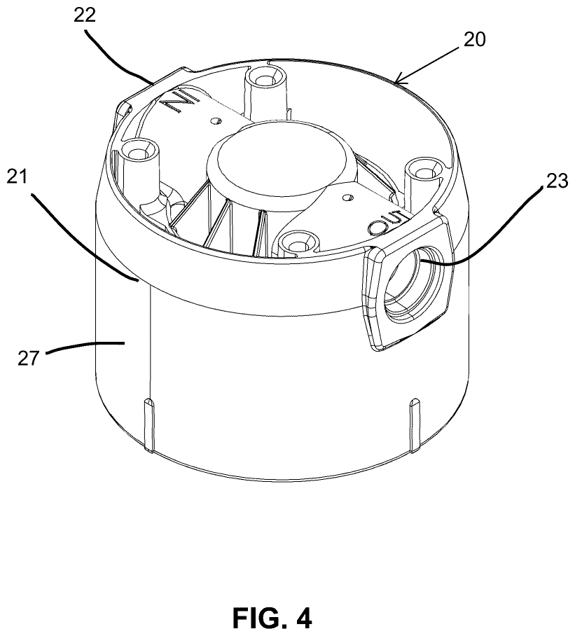

The filter head 20 is illustrated alone in FIGS. 4-6 and with the filter cartridge 40 in FIGS. 7-16. The filter head 20 has a frame 21, an inlet port 22 for receiving water from a water supply as described herein, an outlet port 23 for delivering water to an outlet as described herein, a fluid receptacle 24 located within the frame 21 and in communication with the inlet port 22 and the outlet port 23, and a connecting structure 25 for connection to the filter cartridge 40. The frame 21 defines a cavity 26 for receiving at least a portion of the connection portion 41 of the filter cartridge 40, and the fluid receptacle 24 is located within the cavity 26 for connection to the fluid connection 44 of the filter cartridge 40. The fluid connection 44 is received within the fluid receptacle 24 to place the fluid connection 44 in fluid communication with the fluid receptacle 24, thereby placing the inlet and outlet ports 22, 23 in fluid communication with the filter cartridge 40 and the filtering components within the filter portion 42. The filter assembly 10 may also include components (not shown) engaged with the filter head 20 to establish connections between the fluid connection 44, the fluid receptacle 24, and the inlet and outlet ports 22, 23. Such components may include one or more conduits, valves, seals, etc., for such purposes. The frame 21 has a depending outer wall 27 that at least partially defines the cavity 26. The outer wall 27 is cylindrical in the embodiment illustrated in FIGS. 4-16.

In one embodiment, the connecting structure 25 includes at least one flange 28 extending inward from the outer wall 27 to engage a locking wing 46 of the filter, and at least one passage 29 to permit vertical passage of the locking wing 46 above the flange 28. The connecting structure 25 in FIGS. 4-16 has two flanges 28 extending inward from opposite sides of the outer wall 27, with two passages 29 defined between the ends of the flanges 28. The terminal edge 30 of each flange 28 is concavely curved, but this configuration may be different in other embodiments. It is understood that the shapes, numbers, contours, positions, and other structural aspects of the flange(s) 28 may be configured to be complementary with the properties of the locking wing(s) 46 of the filter cartridge 40. The locking wings 46 of the filter cartridge 40 may pass through the passages 29 of the filter head 20 until the lips 47 of the locking wings 46 are located above the tops 34 of the flanges 28. The filter cartridge 40 may then be engaged with the filter head 20 by rotating the filter cartridge 40 relative to the filter head 20 (counterclockwise in the embodiment of FIGS. 1-16) until the lips 47 rest on the tops 34 of the flanges 28. In this position, each flange 28 is received within the space 48 between the underside of the corresponding lip 47 and the upper side of the base 45, and each flange 28 engages the underside of the lip 47 to retain the connection portion 41 in connection with the filter head 20. The engagement of the locking wings 46 and the flanges 28 retains the filter cartridge 40 in connection with the filter head 20. Disconnection can be accomplished in a reverse procedure.

The connecting structure 25 in one embodiment also includes at least one protrusion 31 extending inward from the outer wall 27 and sized to be received through the slot(s) 51 in the locking wing(s) 46 of the filter cartridge 40. In the embodiment of FIGS. 4-16, the connecting structure 25 has two protrusions 31 extending inward from opposite sides of the outer wall 27. The protrusions 31 extend inward within the passages 29, such that when the locking wings 46 pass through the passages 29, the protrusions 31 pass through the slots 51. In various embodiments, the protrusion(s) 31 may be configured and positioned in the same manner as the slot(s) 51. For example, the protrusions 31 in FIGS. 4-16 have the same rotational symmetry as the slots 51 in the filter cartridge 40 of FIGS. 1-16. In this configuration, each of the slots 51 receives one of the protrusions 31 therethrough. In another embodiment, the filter cartridge 40 may include multiple slots 51, such as in the embodiment of FIGS. 1-3, and the filter head 20 may include only one protrusion 31, such that only one of the slots 51 receives a protrusion 31 therethrough during insertion of the filter cartridge 40.

Further, each protrusion 31 in the embodiment of FIGS. 4-16 has a ramped surface 32 positioned on the leading edge (viewed from the top, defined in a counterclockwise direction). The ramped surface 32 engages the locking wing 46 (e.g., a surface of the slot 51) when the filter cartridge 40 is rotated, to assist in raising the locking wing 46 above the level of the protrusion 31, in case the filter cartridge 40 has not been inserted sufficiently far to clear the protrusion 31 and the flange 28. The protrusions 31 may be configured such that the top surfaces 33 of the protrusions 31 are at the same vertical height as the tops 34 of the flanges 28, such that the protrusions 31 (and the ramped surfaces 32, if present) can guide the locking wings 46 to the proper heights for clearing the tops 34 of the flanges 28. The offset of the slots 51 from the lateral centerline CL in the counterclockwise direction in this embodiment further assists with this, as the locking wings 46 remain in engagement with the top surfaces 33 of the protrusions 31 over a longer rotational distance. The use of the slots 51 and the protrusions 31 may also provide a unique insertion structure, such that improper filter cartridges 40 cannot be inserted.

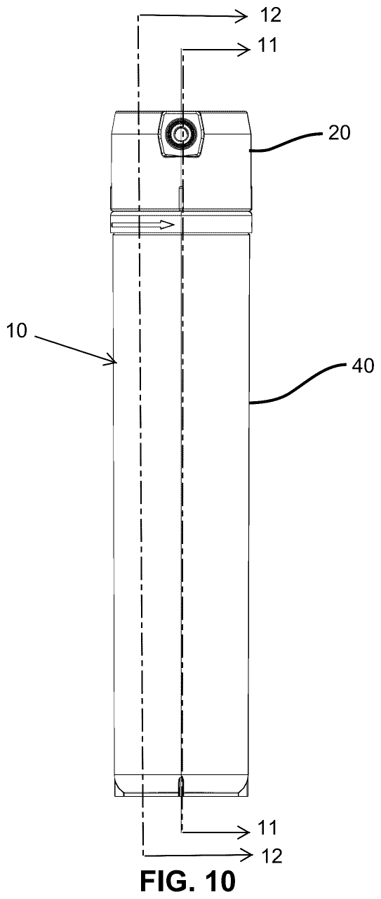

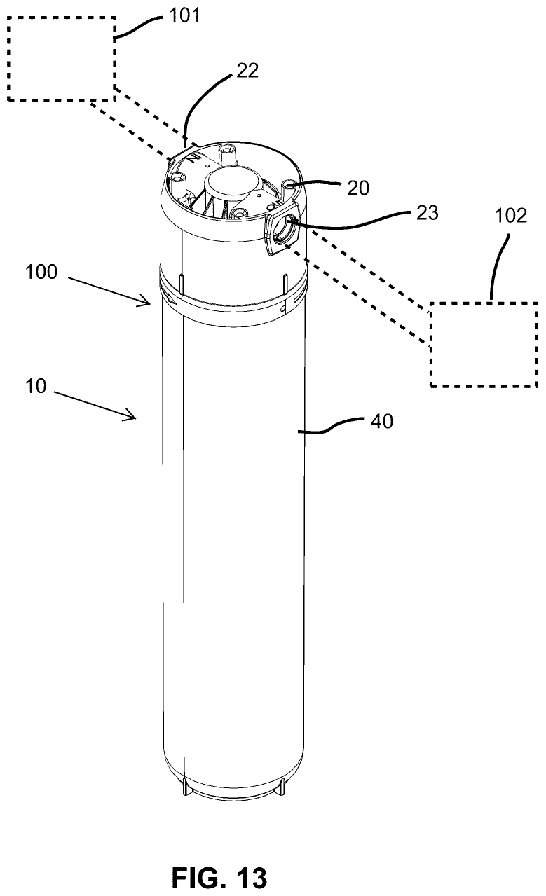

Insertion and locking of the filter cartridge 40 into the filter head 20 is shown in FIGS. 7-16. FIGS. 7-9 illustrate the filter cartridge 40 partially inserted into the filter head 20, such that the locking wings 46 are passing through the passages 29 in the filter head 20, and the protrusions 31 are passing through the slots 51. FIGS. 10-12 illustrate the filter cartridge 40 being vertically inserted completely into the filter head 20, such that the undersides of the lips 47 are located above the top surfaces 33 of the protrusions 31 and the tops 34 of the flanges 28. FIGS. 13-16 illustrate the filter assembly 10 after the filter cartridge 40 is rotated approximately 90° counterclockwise relative to the position in FIGS. 10-12, and the flanges 28 are engaged with the locking wings 46 as described herein.

The filter head 20 is illustrated to receive upward vertical insertion of the filter cartridge 40 in the embodiments described herein, and the directions and orientations described herein are made with respect to that upward vertical orientation. It is understood that these directions are merely relative directions, and are used herein for illustrative purposes. The filter head 20 and the filter cartridge 40 may be arranged in other orientations in another embodiment, such that the filter head 20 may be configured to receive insertion of the filter cartridge 40 in any direction.

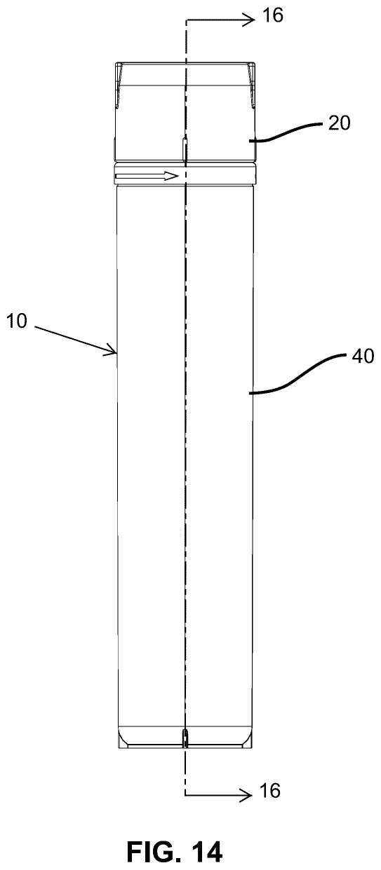

The filter assembly 10 disclosed herein may be incorporated into a water dispenser assembly 100 as shown in FIG. 14, such as a water fountain, a bottle filler, a sink, a different type of water dispenser (e.g., a refrigerator water dispenser), a machine that dispenses water in a non-liquid form (e.g., an ice maker), or an assembly that includes two or more of such water dispensers, which may be of the same or different types. In general, the water dispenser assembly 100 may include the filter head 20 as a permanent component, with the filter cartridge 40 being removed and replaced as necessary. The inlet port 22 may be connected to a water supply 101, and the outlet port 23 may be connected to an outlet 102, such as a spout, spigot, or other outlet. It is understood that additional components may be included in the water dispenser assembly 100 between the water supply 101 and the inlet port 22 and/or between the outlet port 23 and the outlet 102. The water dispenser assembly 100 may include further components, such as casings or housings, mounting structures, actuators (e.g., buttons, levers, touch panels, handles, etc.), drains, and other such components. The filter head 20 may be mounted inside a casing or housing in one embodiment, which may provide access for interchanging the filter cartridge 40, such as via a door or panel.

Various embodiments of filter assemblies and components thereof have been described herein, which include various components and features. In other embodiments, the filter assembly, filter cartridge, and/or filter head may be provided with any combination of such components and features. It is also understood that in other embodiments, the various devices, components, and features of the filter assembly, filter cartridge, and/or filter head described herein may be constructed with similar structural and functional elements having different configurations, including different ornamental appearances.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the spirit or central characteristics thereof. The present examples and embodiments, therefore, are to be considered in all respects as illustrative and not restrictive, and the invention is not to be limited to the details given herein. The terms “top,” “bottom,” “front,” “back,” “side,” “rear,” “proximal,” “distal,” and the like, as used herein, are intended for illustrative purposes only and do not limit the embodiments in any way. Nothing in this specification should be construed as requiring a specific three dimensional orientation of structures in order to fall within the scope of this invention, unless explicitly specified by the claims. When used in description of a method or process, the term “providing” (or variations thereof) as used herein means generally making an article available for further actions, and does not imply that the entity “providing” the article manufactured, assembled, or otherwise produced the article. The term “approximately” as used herein implies a variation of up to 10% of the nominal value or property modified by such term, or up to 10% of a midpoint value of a range modified by such term. “Integral joining technique,” as used herein, means a technique for joining two pieces so that the two pieces effectively become a single, integral piece, including, but not limited to, irreversible joining techniques such as welding, brazing, soldering, or the like, where separation of the joined pieces cannot be accomplished without structural damage thereto. Additionally, the term “plurality,” as used herein, indicates any number greater than one, either disjunctively or conjunctively, as necessary, up to an infinite number. Accordingly, while the specific embodiments have been illustrated and described, numerous modifications come to mind without significantly departing from the spirit of the invention and the scope of protection is only limited by the scope of the accompanying claims.

What is claimed is:

1. A filter cartridge for a water dispenser, comprising:
a filter portion comprising a casing containing filtering components configured for filtering water to be supplied to the water dispenser; and
a connection portion connected to a top end of the filter portion, the connection portion comprising:
a base connected to the top end of the filter portion;
a fluid connection extending upward from the base, wherein the fluid connection is in fluid communication with the filter portion and configured to permit passage of the water into and/or out of the filter portion; and
a first locking wing connected to the base and extending outward on a first side of the base, the first locking wing having a first lip extending outwardly such that a first space is defined between an underside of the first lip and an upper side of the base, wherein the first locking wing is configured to engage a first flange on a filter head and to receive the first flange in the first space to lock the filter cartridge in connection with the filter head.

2. The filter cartridge of claim 1, wherein the connection portion further comprises a plurality of locking wings including the first locking wing, each connected to the base and extending outward, each locking wing having a lip extending outwardly such that a space is defined between an underside of each lip and the upper side of the base, wherein each locking wing is configured to engage a corresponding flange on the filter head and to receive the corresponding flange in the space to lock the filter cartridge in connection with the filter head.

3. The filter cartridge of claim 2, wherein the plurality of locking wings are arranged in a rotationally symmetrical manner to define a number of identical rotational positions equal to a number of the plurality of locking wings.

4. The filter cartridge of claim 1, wherein the first lip has a first terminal edge distal from the fluid connection, and a slot extending inward from the first terminal edge.

5. The filter cartridge of claim 1, wherein the connection portion further comprises a second locking wing connected to the base and extending outward on a second side of the base opposite to the first side, such that the first and second locking wings are positioned on opposite sides of the fluid connection, the second locking wing having a second lip extending outwardly such that a second space is defined between an underside of the second lip and the upper side of the base, wherein the second locking wing is configured to engage a second flange on the filter head and to receive the second flange in the second space to lock the filter cartridge in connection with the filter head.

6. The filter cartridge of claim 5, wherein the first and second locking wings are arranged in a rotationally symmetrical manner to define two identical rotational positions of the connection portion.

7. The filter cartridge of claim 5, wherein the first lip has a first terminal edge distal from the fluid connection and a first slot extending inward from the first terminal edge, and the second lip has a second terminal edge distal from the fluid connection and a second slot extending inward from the second terminal edge.

8. The filter cartridge of claim 7, wherein the first slot and the second slot are offset from a lateral centerline of the filter cartridge that passes through lateral centers of both the first locking wing and the second locking wing and through a lateral center of the fluid connection, and the first slot and the second slot are positioned on opposite sides of the lateral centerline.

9. A connection portion for a filter cartridge for a water dispenser, comprising:
a base configured for connection to a top end of a filter portion configured for filtering water to be supplied to the water dispenser;
a fluid connection extending upward from the base, wherein the fluid connection is configured to be in fluid communication with the filter portion and configured to permit passage of the water into and/or out of the filter portion;
a first locking wing connected to the base and extending outward on a first side of the base, the first locking wing having a first lip extending outwardly such that a first space is defined between an underside of the first lip and an upper side of the base, wherein the first locking wing is configured to engage a first flange on a filter head and to receive the first flange in the first space to lock the filter cartridge in connection with the filter head; and
a second locking wing connected to the base and extending outward on a second side of the base opposite to the first side, such that the first and second locking wings are positioned on opposite sides of the fluid connection, the second locking wing having a second lip extending outwardly such that a second space is defined between an underside of the second lip and the upper side of the base, wherein the second locking wing is configured to engage a second flange on the filter head and to receive the second flange in the second space to lock the filter cartridge in connection with the filter head.

10. The connection portion of claim 9, wherein the first and second locking wings are arranged in a rotationally symmetrical manner to define two identical rotational positions of the connection portion.

11. The connection portion of claim 9, wherein the first lip has a first terminal edge distal from the fluid connection and a first slot extending inward from the first terminal edge, and the second lip has a second terminal edge distal from the fluid connection and a second slot extending inward from the second terminal edge.

12. The connection portion of claim 11, wherein the first slot and the second slot are offset from a lateral centerline of the filter cartridge that passes through lateral centers of both the first locking wing and the second locking wing and through a lateral center of the fluid connection, and the first slot and the second slot are positioned on opposite sides of the lateral centerline.

13. The connection portion of claim 12, wherein the first slot and the second slot are offset equal distances from the lateral centerline, and the first and second locking wings are arranged in a rotationally symmetrical manner to define two identical rotational positions of the connection portion.

14. The connection portion of claim 11, wherein the first terminal edge and the second terminal edge are convexly curved.

15. A filter assembly for a water dispenser, comprising:
a filter head comprising a frame having an outer wall defining a cavity, the cavity including a fluid receptacle, and a connecting structure comprising a first flange extending inward from the outer wall; and
a filter cartridge connected to the filter head and comprising:
a connection portion comprising a base, a fluid connection extending upward from the base and received within the fluid receptacle to place the fluid connection in fluid communication with the fluid receptacle, and a first locking wing connected to the base and extending outward on a first side of the base, the first locking wing having a first lip extending outwardly, wherein the connection portion is at least partially received in the cavity and is connected to the filter head, such that the first flange engages an underside of the first lip to lock the connection portion in connection with the filter head; and
a filter portion configured for filtering water to be delivered to the water dispenser, the filter portion having a top end connected to the base of the connection portion, wherein the fluid connection of the connection portion is in fluid communication with the filter portion and configured to permit passage of the water into and/or out of the filter portion through the fluid receptacle.

16. The filter assembly of claim 15, wherein the filter head further comprises an inlet port in fluid communication with the fluid receptacle and configured for receiving the water from a water supply and an outlet port in fluid communication with the fluid receptacle and configured for delivering the water to an outlet of the water dispenser, wherein the fluid connection is configured to permit passage of the water from the inlet port into the filter portion and to permit passage of water out of the filter portion and into the outlet port, via the fluid receptacle.

17. The filter assembly of claim 15, wherein the connecting structure of the filter head further comprises a second flange extending inward from the outer wall, wherein the connection portion further comprises a second locking wing connected to the base and extending outward on a second side of the base opposite the first side, the second locking wing having a second lip extending outwardly, and wherein the connection portion is further connected to the filter head such that the second flange engages an underside of the second lip to lock the connection portion in connection with the filter head.

18. The filter assembly of claim 17, wherein the connecting structure of the filter head further comprises passages between the first flange and the second flange, wherein the filter cartridge is configured to be releasably connectable to the filter head by inserting the connection portion into the cavity such that the fluid connection is received in the fluid receptacle and the first locking wing and the second locking wing pass upwardly through the passages, and subsequently rotating the filter cartridge to cause the first flange to engage the underside of the first lip of the first locking wing and to cause the second flange to engage the underside of the second lip of the second locking wing.

19. The filter assembly of claim 18, wherein the connecting structure of the filter head further comprises protrusions extending inwardly from the outer wall within the passages, wherein the first lip has a first terminal edge distal from the fluid connection and a first slot extending inward from the first terminal edge, and the second lip has a second terminal edge distal from the fluid connection and a second slot extending inward from the second terminal edge, and wherein the protrusions are configured to pass through the first slot and the second slot when the first locking wing and the second locking wing are inserted upward through the passages.

20. The filter assembly of claim 19, wherein each of the protrusions has a ramped surface, and the ramped surfaces of the protrusions are configured to engage the first locking wing and the second locking wing when the filter cartridge is rotated, to assist in raising the first locking wing and the second locking wing above the protrusions.
